(19) United States
(12) Patent Application Publication
(10) Pub. No.: US 2026/0214101 A1
(43) Pub. Date: Jul. 23, 2026

(54) System and Method for Architectural Preservation of Identity Continuity Under Interruption Across Heterogeneous Compute Environments

(71) Applicant: Joshua Zaris Goldman, St. Petersburg, FL (US)

(72) Inventor: Joshua Zaris Goldman, St. Petersburg, FL (US)

(21) Appl. No.: 19/454,568

(22) Filed: Jan. 21, 2026

(51) Int. Cl. H04L 9/40; G06F 21/62

(52) U.S. Cl. CPC H04L 63/108; G06F 21/6245

(57) ABSTRACT

A system and method for maintaining identity continuity of an entity under interruption are disclosed. The system maintains a persistent internal state that represents the entity independently of continuous external observation and preserves an identity authority association between the entity and the persistent internal state during interruption conditions including degradation, delay, partial unavailability, unreliability, or out-of-order receipt of telemetry. Upon receipt or availability of restored information, including restored telemetry, validated re-association is performed to re-establish the identity authority association and preserve identity continuity without reinitializing the persistent internal state. The system operates across heterogeneous compute environments and tolerates latency, partial synchronization, and asynchronous execution. By preserving identity continuity as an architectural invariant without forced reinitialization, the system mitigates identity ambiguity, duplicate identity instantiation, identity drift, and distributed state divergence that otherwise degrade system correctness under real-world operating conditions where interruption is expected rather than exceptional.

### CROSS-REFERENCE TO RELATED APPLICATIONS

This application claims priority to U.S. Provisional Patent Application No. 63/959,044, filed Jan. 12, 2026, which is incorporated by reference in its entirety.

### TECHNICAL FIELD

The present invention relates generally to distributed computing systems, spatial systems, cyber-physical systems, and platform-level state management architectures. More particularly, it relates to systems and methods that preserve identity continuity of entities when observation or telemetry is interrupted, degraded, delayed, partially unavailable, unreliable, or received out of order, including during distributed execution across heterogeneous compute environments such as edge, cloud, and hybrid environments.

### BACKGROUND OF THE INVENTION

Modern distributed, spatial, and cyber-physical systems increasingly operate under conditions in which continuous observation, sensing, or telemetry cannot be assumed. Occlusion, signal degradation, intermittent connectivity, latency, environmental interference, asynchronous execution, and cross-domain handoff between heterogeneous compute environments are common during normal operation rather than exceptional events.

Many existing systems implicitly infer identity from uninterrupted observation or continuous telemetry. When observation becomes incomplete or unavailable, such systems commonly experience identity drift, duplicate instantiation, incorrect reassociation, or forced reinitialization of internal state. These failures propagate to downstream subsystems that consume identity as a referential key, increasing computational overhead, disrupting continuity of operation, and often requiring manual intervention to restore correct behavior.

Conventional approaches to interruption handling typically rely on localized heuristics, estimation techniques, or component-specific recovery logic, which may exhibit limitations when applied in distributed architectures spanning heterogeneous compute environments with differing latency, synchronization, and authority boundaries. As systems increase in complexity and distribution, interruption-induced identity failure modes become more frequent and more costly.

Accordingly, there exists a need for architectures that preserve identity continuity across interruption and recovery without requiring uninterrupted observation, forced reinitialization, or brittle recovery logic. Such architectures should operate coherently across distributed and heterogeneous compute environments, tolerate partial observability and asynchronous execution, and maintain stable identity relationships where interruption is expected.

Existing approaches generally treat interruption handling as a recovery problem. In contrast, the architectures described in this disclosure treat loss of identity continuity itself as a technical failure mode and assign system-level responsibility for preserving identity continuity under interruption as an architectural invariant, including across heterogeneous execution and authority transitions.

### SUMMARY OF THE INVENTION

The present invention provides a system and method for maintaining identity continuity of an entity under interruption. The system maintains a persistent internal state that represents the entity independently of continuous external observation and preserves an association between the entity's identity and the persistent internal state during periods of interruption.

When restored information becomes available after an interruption, the restored information is evaluated against the persistent internal state to determine correspondence. When correspondence is validated, identity continuity is preserved using the persistent internal state without reinitializing the state in response to the interruption.

In certain embodiments, identity continuity is preserved across heterogeneous compute environments, including edge, cloud, and distributed execution environments, despite latency, partial synchronization, or asynchronous execution. Authority over the persistent internal state may transition between compute environments without disrupting identity continuity.

Loss of identity association is treated as a technical failure mode in distributed and heterogeneous systems. These architectures reduce or avoid forced reinitialization, mitigate identity drift and duplicate instantiation, and limit downstream error propagation by preserving identity continuity as a system-level architectural invariant rather than as an emergent or component-level behavior.

The disclosed subject matter is rooted in computer technology and addresses challenges specific to distributed execution under interruption, including partial observability, asynchronous execution, and cross-domain state handoff. The resulting technical effects arise from architectural arrangements that preserve identity continuity under interruption, rather than from improvements to any particular mathematical model, data representation, or inference algorithm. FIG. 4 illustrates example interruption-induced failure modes in baseline systems and the corresponding continuity-preserving behaviors.

### BRIEF DESCRIPTION OF THE DRAWINGS

FIG. 1 illustrates an example system architecture (100) for maintaining identity continuity under interruption. Telemetry associated with an entity (102) is received through a data acquisition interface (104), which may be implemented via one or more acquisition layers that aggregate, normalize, or mediate telemetry from heterogeneous sources. The telemetry is provided to a transformation engine (106) used to maintain a persistent internal state (108) representing the entity independently of continuous external observation. One or more remapped representations (114) may be derived from the persistent internal state (108) for downstream use without altering the underlying identity association. A persistent state-link (110) maintains an association between an identity of the entity and the persistent internal state (108) across time and interruption. Upon availability of restored information, the restored information may be evaluated against the persistent internal state to maintain identity continuity without reinitialization. The architecture operates across one or more compute environments (112), including edge, cloud, or distributed execution environments.

FIG. 2 illustrates an example operational flow for maintaining identity continuity during interruption and recovery. Telemetry ingestion (202) updates a persistent internal state (204) during normal operation. An interruption event (206) causes telemetry to become unavailable, degraded, delayed, or unreliable. During interruption, identity continuity may be preserved by maintaining the persistent internal state and an associated persistent state-link (208), while a confidence measure change over time (210) associated with the persistent internal state occurs. Upon availability of restored information (212), the system evaluates that information against the persistent internal state to determine correspondence (214). When correspondence is validated, identity continuity is preserved (216) using the persistent internal state without reinitialization. If correspondence is not validated, additional validation or continuity-handling behavior may be invoked.

FIG. 3 illustrates an example embodiment in which identity continuity is maintained across heterogeneous compute environments. Telemetry associated with an entity (302) is processed across multiple execution domains, including an edge compute environment (304) and a cloud or distributed compute environment (306). A persistent internal state (308) and associated persistent state-link (310) are maintained as execution, priority, or authority transitions occur between compute environments. Differences in latency, synchronization, or update rates between compute environments do not require reinitialization of the persistent internal state. Identity continuity may be preserved across domain transitions, including during interruption, partial observability, or asynchronous execution.

FIG. 4 illustrates an example interruption-to-failure chain in baseline systems. Interruption conditions (402), including degradation, delay, reordering, or partial observability, may lead to identity ambiguity (404), duplicate identity instantiation (406), identity drift (408), distributed state divergence (410), or reset cascades (412). FIG. 4 further illustrates maintenance of an identity authority association (414) and validated re-association (416) that preserve identity continuity as a system-level invariant without forced reinitialization.

FIG. 5 illustrates an example downstream integration (500) in which an identity authority output (502) generated by the synchronization interface is provided to one or more downstream subsystems (504). The downstream subsystems (504) are configured to condition identity instantiation, state propagation, or actuation behavior (506) on the identity authority output (502), such that behavior (506) associated with identities lacking a current identity authority association during interruption is suppressed without requiring reinitialization.

### DETAILED DESCRIPTION OF THE INVENTION

### Definitions and Terminology

For purposes of this disclosure, the following definitions apply:
Entity: A physical object, person, biological system, mechanical system, or digital construct, whether acting as a singular unit or a distributed collective or swarm, possessing a distinguishable identity and a time-varying state.
Persistent Internal State: A maintained internal representation of an entity that encodes state information sufficient to support identity continuity independent of continuous external observation.
Persistent State-Link: A maintained association between an entity identity and a corresponding persistent internal state across time, interruption, and execution domains, wherein the association remains addressable during interruption independent of continuous observation.
Identity Authority Association: A maintained system-level association between an entity identity and a corresponding persistent internal state, which determines whether the identity is considered valid for use by downstream system components during and following interruption.
Identity Authority Output: A machine-consumable output that represents the identity authority association for an entity, including an authorization state and optionally a confidence bound or revocation state, usable by downstream system components to govern whether the identity is instantiated, used, or propagated during and following interruption.
Validated Re-Association: A process of verifying correspondence between restored information and a preserved persistent internal state prior to reasserting identity authority, without reinitializing the persistent internal state.
Reinitialization: Includes any process in which an internal state associated with a previously known entity is purged, replaced, superseded, or assigned a new identity reference, regardless of whether historical data, metadata, or prior observations are retained or later merged.
Remapped Representation: A digital or physical representation derived from an entity or its persistent internal state, including but not limited to surface geometry, visual appearance, spatial configuration, or functional state, which may differ from the entity's externally observable surface.
Surface-Independent State Mapping (SISM): A technique for generating and maintaining a persistent internal state or remapped representation of an entity based on internal state models and multi-modal data fusion rather than reliance on continuous external surface visibility or optical observation.
Identity Signature: A state-derived representation used to support continuity validation and asserted association, generated from one or more elements of the persistent internal state and optionally from telemetry-derived features, wherein no particular feature type is required and wherein the identity signature may be probabilistic, composite, and confidence-bounded, and is evaluated relative to the persistent internal state, rather than being used as an independent tracking identifier. Identity signatures may include behavioral, kinematic, or state-evolution characteristics derived from the persistent internal state.
Heterogeneous Compute Environment: A system comprising two or more compute domains, including but not limited to edge devices, cloud infrastructure, local processing nodes, or specialized accelerators, operating under differing hardware, software, or network conditions.
Identity Continuity: The preservation of a stable association between an entity's identity and a corresponding persistent internal state across time, interruption, and execution contexts, regardless of changes in observability or compute environment.
Interruption: Any condition in which telemetry associated with an entity is degraded, delayed, partially unavailable, unreliable, or otherwise insufficient to maintain continuous identity association using continuous observation or telemetry-based association alone, including transitions to low-confidence, predictive, or inferred state modes.
Telemetry: Information associated with an entity, including sensor-derived observations, inferred state information, inter-agent communication, peer-to-peer state updates, and continuity information exchanged between system components or external observers, regardless of whether such information originates from a physical sensor, a distributed agent, or a software-based observer.
Continuity Validation Criterion: One or more system-defined conditions used to determine whether telemetry, state artifacts, or contextual information are sufficient to support identity continuity, wherein the criterion may be static, adaptive, context-dependent, policy-based, or learned, and may differ across entities or compute domains.
Correspondence Artifact: Information used to establish correspondence between restored information and a persistent internal state, including telemetry, state artifacts, checkpoint identifiers, state digests, authority attestations, or other continuity-related representations derived from or associated with the persistent internal state.
Restored Information: Information available following an interruption that may be used to perform validated re-association, including restored telemetry, correspondence artifacts, or both.

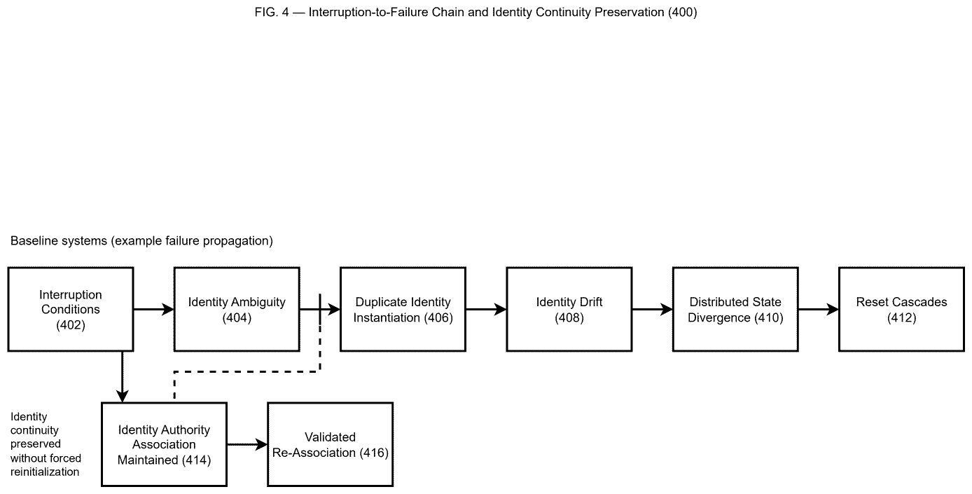

In distributed and heterogeneous systems, interruption causes loss of reliable association between an entity and system state. Loss of association degrades system correctness by introducing identity ambiguity, which may result in duplicate entity instantiation, identity drift, inconsistent state updates across nodes, reset cascades, or corruption of downstream subsystems that consume entity identity as a referential key. FIG. 4 illustrates this interruption-to-failure chain in baseline systems. These architectures maintain identity continuity as a system-level invariant by preserving identity authority association across interruption and by performing validated re-association without forced reinitialization.

### System Architecture

In one embodiment, the system comprises:
A data acquisition interface (104), which may comprise one or more acquisition layers, configured to ingest multi-modal telemetry associated with an entity (102), agnostic to sensor modality (including active, passive, or self-reported data), including physical sensor data, inferred state data, or digital metadata;
A transformation engine (106) configured to generate and update the persistent internal state (108) using one or more inference mechanisms selected according to telemetry availability and quality, wherein this disclosure is directed to architectural state-management responsibilities and continuity behavior rather than any particular inference algorithm. In certain embodiments, the transformation engine is further configured to support one or more of the following optional behaviors:
   Graceful Degradation: Adjusting the confidence decay function based on the number and quality of active telemetry streams to maintain the persistent state-link even during partial telemetry failure. As used herein, a confidence decay function refers to a mechanism for quantifying accumulated uncertainty in the persistent internal state during periods of degraded or absent telemetry;
   Contextual Awareness: Incorporating environmental constraints (e.g., collision volumes, digital twins of physical spaces, or gravity models) to ensure the remapped representation (114) maintains spatial validity;
   Schema-Agnostic State Mapping: Utilizing a version-flexible internal state model (108) that ensures backward and forward compatibility across heterogeneous compute environments with differing software versions or API protocols. This enables the internal state model to remain interoperable across differing data schemas, software versions, or interface definitions without requiring reinitialization or loss of identity continuity;
   State-Link Bifurcation: Configuring the internal state model (108) to support dynamic bifurcation or fusion, allowing the persistent state-link to maintain continuity even when a collective entity (e.g., a swarm or distributed system) splits into multiple discrete units or merges into a single unit;
A synchronization interface configured to maintain a persistent state-link between the persistent internal state (108) and one or more remapped representations (114) across heterogeneous compute environments (112).

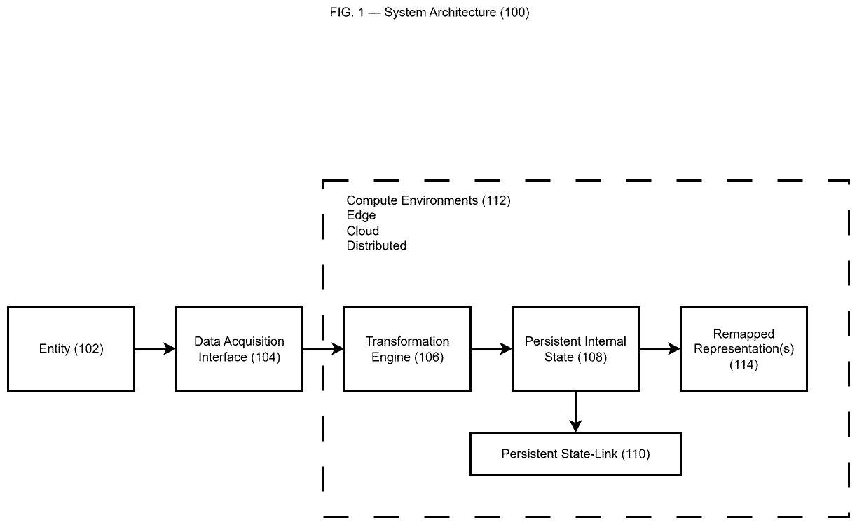

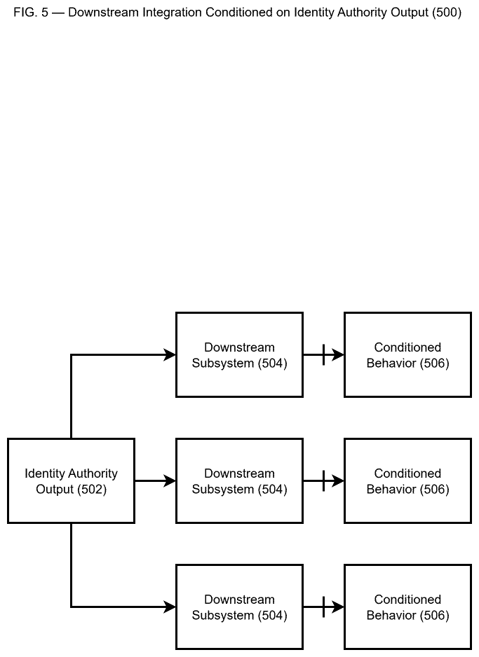

As illustrated in FIG. 1, the system architecture is configured to preserve identity continuity under interruption by preserving a persistent internal state (108) associated with an entity (102) via a persistent state-link (110). Telemetry received through the data acquisition interface (104) may update the persistent internal state during periods of observation, while the persistent state-link maintains the association between identity and state during interruption. Upon availability of restored information associated with the entity, the restored information may be evaluated against the persistent internal state to determine correspondence and to continue identity continuity without reinitialization. The architecture may operate across one or more heterogeneous compute environments (112). The synchronization interface may further generate an identity authority output consumable by downstream subsystems, as illustrated in FIG. 5.

### Surface-Independent State Mapping (SISM)

In certain embodiments, a persistent internal state representing an entity may be generated and maintained using surface-independent state mapping (SISM).

Surface-independent state mapping decouples identity preservation from reliance on any specific externally visible surface or continuous observation. A persistent internal state may be constructed from multi-modal telemetry and contextual information, and a remapped representation may be derived from the persistent internal state such that changes to, or occlusion of, the entity's externally observable surface do not disrupt identity continuity.

This surface-independent state mapping enables identity continuity to be preserved even when the entity is partially or fully unobservable by one or more sensors.

### Persistent State-Link Maintenance

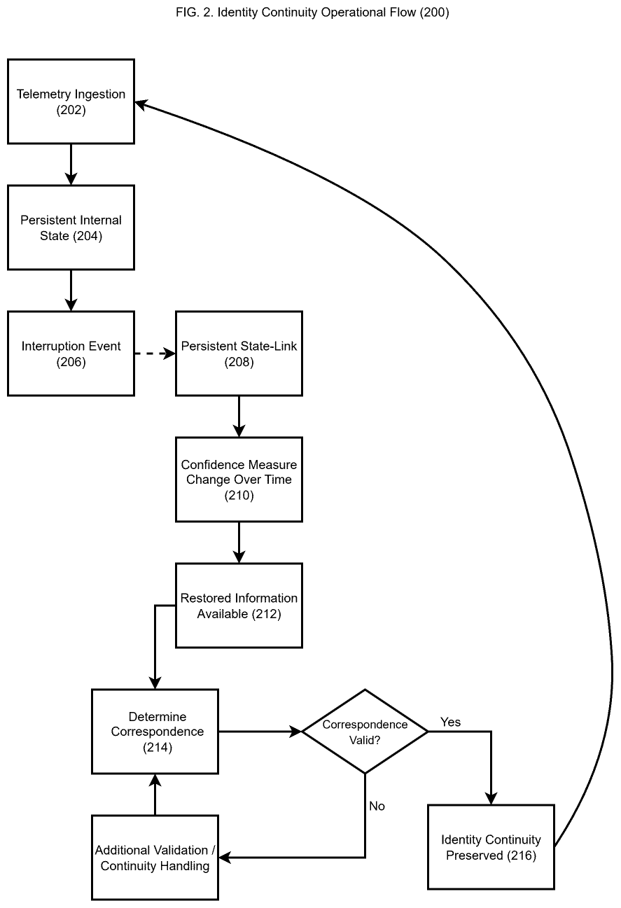

As illustrated in FIG. 2, the synchronization interface maintains identity continuity through a primary operational loop that includes telemetry ingestion (202), updates to a persistent internal state (204), interruption handling (206), and recovery behavior.

During normal operation, the persistent internal state is updated using telemetry-derived inputs. One or more identity signatures may be generated as state-derived representations based on elements of the persistent internal state and, in certain embodiments, additional telemetry-derived features. These identity signatures are evaluated relative to the persistent internal state to support continuity validation and maintenance of the identity authority association.

Correspondence validation is performed relative to one or more continuity validation criteria, which determine whether telemetry, state artifacts, or contextual information are sufficient to re-establish an identity authority association without reinitialization. The continuity validation criteria may include one or more of temporal consistency, state plausibility, authority context, or correspondence artifacts derived from the persistent internal state. To maintain a current baseline, identity signatures may be dynamically updated during the primary loop to account for temporal variation in entity behavior, including changes in posture, movement dynamics, environmental context, or sensor noise.

Identity signatures, together with associated state vectors, may be codified into versioned state checkpoints that provide a stable temporal reference for synchronization and recovery. Identity signatures may be implemented as anonymized, one-way cryptographic hashes, allowing continuity to be preserved without storing raw biometric or personally identifiable information. The system may maintain multiple candidate state hypotheses concurrently, including probabilistic or confidence-bounded alternatives, until correspondence validation resolves the identity authority association. In such configurations, the identity authority output may be consumed by one or more downstream subsystems to suppress identity instantiation, state propagation, or actuation for identities lacking current identity authority association during interruption, as illustrated in FIG. 5.

During an interruption condition (206), the system exits the primary update loop and maintains state continuity based on the most recent versioned state checkpoint, while a confidence measure associated with the persistent internal state may evolve over time (210). During this period, constrained extrapolation may be applied using known environmental or contextual boundaries to prevent violations of physical or logical constraints. If accumulated uncertainty exceeds a predefined threshold, the system may modify continuity behavior by restricting downstream actuation while preserving identity authority association and without reinitializing the persistent internal state. Loss of identity authority association during interruption constitutes a continuity failure and is distinct from confidence-based restriction of downstream actuation or output gating.

In scenarios involving entity proximity or overlap, the transformation engine may apply identity-aware conflict resolution using stored identity signatures to maintain discrete persistent state-links and reduce ambiguity.

Upon availability of restored information (212), restored telemetry or correspondence artifacts are evaluated against the persistent internal state and associated identity signatures to perform validated re-association and determine correspondence (214) using deterministic, probabilistic, or hybrid techniques. In certain embodiments, restored telemetry may be used to retroactively reconcile state estimates generated during interruption for auditability or verification, without reinitializing the persistent internal state.

Once correspondence is validated, the system returns to the primary update loop and continues identity continuity using the persistent internal state without reinitialization (216), which can reduce latency and computational overhead in real-time and near-real-time applications.

### Distributed and Heterogeneous Operation

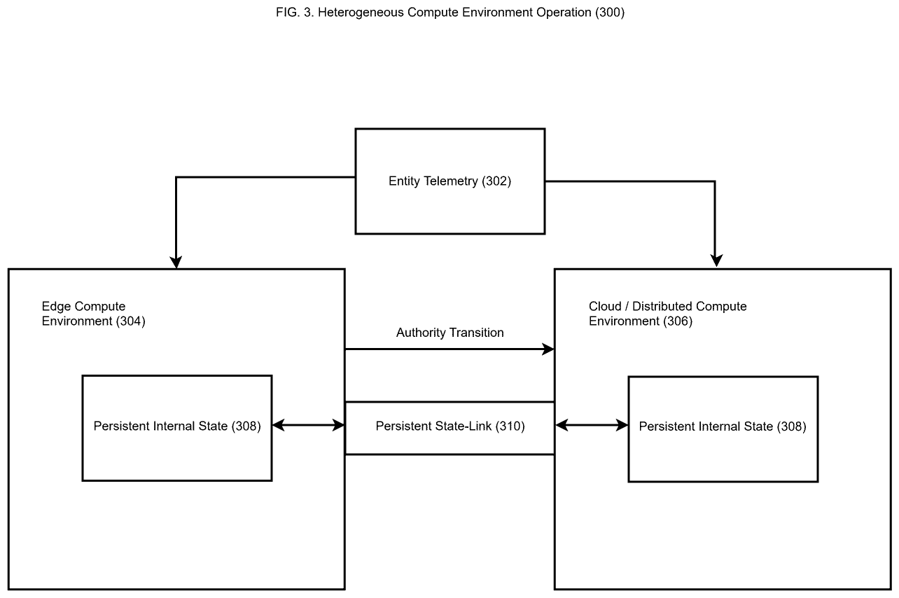

As illustrated in FIG. 3, identity continuity may be preserved across heterogeneous compute environments. A persistent internal state (308) and associated persistent state-link (310) may be maintained as execution transitions between an edge compute environment (304) and a cloud or distributed compute environment (306).

In distributed embodiments, the persistent state-link is maintained across multiple compute domains using reconciliation protocols that tolerate latency, packet loss, and domain transitions. Synchronization may occur on a continuous, periodic, or event-driven basis to optimize bandwidth utilization. In cases of state divergence, authority weighting may be applied, prioritizing the edge domain for low-latency feedback while maintaining the cloud or distributed domain as an authoritative record for checkpoint retention and reconciliation without centralizing identity authority.

In certain embodiments, the synchronization interface includes a temporal reconciliation layer configured to mitigate clock drift and network jitter using non-monotonic time-stamping, relative-offset logic, or similar techniques that do not rely on globally synchronized clocks. The interface may further support state handoff, in which the authoritative record and associated state-link migrate between compute nodes based on proximity, signal quality, or execution context to reduce transition latency.

Resource-aware orchestration may also be employed, dynamically adjusting transformation engine workload and synchronization frequency based on thermal state, power availability, or local compute pressure within an edge environment, supporting continued identity persistence under constrained operating conditions.

### Adverse and Ambiguous Operating Conditions

In certain operating environments, multiple entities may generate overlapping or ambiguous telemetry, experience interruption concurrently, or re-enter observation in close temporal or spatial proximity. Additionally, telemetry associated with an entity may be received out of order, delayed, or subject to clock skew across heterogeneous compute environments.

In such scenarios, the system is configured to maintain separate persistent internal states and associated persistent state-links, allowing identity continuity to be preserved independently for each entity. Validated re-association may incorporate temporal consistency, state plausibility, or authority context to resolve ambiguity without requiring forced reinitialization or manual intervention. Authority over the persistent internal state may transition between compute environments while maintaining identity continuity despite asynchronous execution or partial observability.

External system-level fault handling, including catastrophic reset or teardown of system components, may occur outside the scope of the identity continuity architecture described above and does not constitute maintenance of identity continuity under interruption. Such external fault handling includes reinitialization performed in response to system reset, safety override, or policy-based revocation, and is distinct from interruption-handling mechanisms that preserve identity continuity.

### Security and Integrity Embodiments (Optional)

In certain embodiments, the system performs integrity validation to reduce unauthorized substitution of telemetry or state updates, including authentication between interfaces and verification of permitted state transitions. Such integrity validation is optional and is not required to maintain identity continuity under interruption as described in this disclosure.

### Bi-Directional State Interaction

The persistent state-link may facilitate bi-directional data flow, wherein state changes in the remapped representation (114) or the compute environments (112) generate feedback telemetry (e.g., haptic, visual, or auditory) delivered back to the source entity (102) to guide physical-to-digital alignment. This feedback may enable closed-loop applications, such as guiding robotic entities via haptic signals derived from the remapped representation.

### Illustrative Embodiments (Non-Limiting)

The following embodiments illustrate architectural applicability and do not require any particular implementation technique, sensor modality, or inference method. These embodiments demonstrate applicability in systems where identity functions as a referential key consumed by downstream subsystems and where interruption may otherwise cause ambiguity, drift, duplication, or reset cascades. The system and method described herein may be applied across a plurality of domains including, but not limited to:
1. Virtual Production & Cinema: Maintaining actor-to-avatar synchronization even during complex stunts or when physical markers are occluded by props or costumes, enabling instantaneous reskinning or appearance changes during live performance capture.
2. Spatial Computing & XR: Ensuring persistent digital overlays on physical objects in Mixed Reality (MR) even when the user's headset loses a direct line of sight, preserving identity and spatial coherence through state continuation under interruption.
3. Defense & Tactical Simulation: Tracking personnel or assets in denied environments where GPS or optical telemetry is jammed or intermittent.
4. Healthcare & Remote Surgery: Maintaining a digital twin of biological systems during procedures where surgical tools or medical staff occlude primary sensors, enabling continuous tele-presence and haptic feedback.
5. Industrial Digital Twins: Managing the state of heavy machinery or infrastructure where
steam, dust, or structural components block continuous observation.
6. Automotive & V2X: Predicting the state of vehicles or pedestrians during blind corner scenarios or sensor washouts due to weather, enabling collision avoidance and identity tracking despite partial occlusion.
7. Robotics & Autonomous Systems: Allowing a robot to maintain an internal model of a handled object even when its hands or grippers fully occlude the object's surface.
8. Space Exploration: Synchronizing state between orbital and planetary assets where signal latency or planetary rotation causes telemetry dropouts.
9. Deep-Sea Exploration: Maintaining identity-consistent models of submersibles or marine life in low-visibility, high-attenuation environments.
10. Tele-presence & Remote Work: Ensuring a high-fidelity remapped representation of a remote participant remains stable during home-network jitter or temporary disconnections, supporting seamless interaction.
11. Sports Analytics: Tracking athlete state and identity during pile-ups or high-speed contact where traditional computer vision typically fails.
12. Infrastructure Management: Monitoring structural integrity of bridges or tunnels where internal sensors provide the state even when the external surface is hidden, supporting predictive integrity assessment.
13. Education & Training: Maintaining persistence in multi-user VR classrooms where learners interact with complex, occludable digital objects, enabling uninterrupted collaborative simulation.
14. Security & Surveillance: Preserving the identity signature of an entity moving through blind spots in a camera network, ensuring continuous tracking despite visual gaps.
15. Retail & Logistics: Tracking the state and identity of goods in dense warehouse environments where items are frequently stacked or hidden, optimizing inventory and flow management.
16. Environmental Monitoring: Maintaining models of wildlife or geological features in habitats where continuous visibility is impossible, enabling long-term behavioral and structural analysis.
17. Gaming & Interactive Media: Providing zero-drop character synchronization in massive multiplayer environments across high-latency connections.
18. Smart Cities & Urban Mobility: Real-time modeling of pedestrian and vehicle flows for predictive crowd behavior analysis, emergency response coordination, and traffic optimization in dense urban environments where camera coverage is intermittent or obstructed.
19. Agriculture & Precision Farming: Real-time monitoring of crop health, soil conditions, and machinery state in fields where drone or satellite views are occluded by foliage, weather, or terrain, enabling predictive interventions and resource optimization.
20. Renewable Energy & Grid Management: Monitoring wind turbine or solar panel states in remote or weather-obscured environments, enabling predictive maintenance and grid stability despite intermittent sensor visibility.
21. Biometric Monitoring: Using state-link synchronization to maintain a continuous health profile of a subject even during sensor displacement or removal, supporting uninterrupted physiological tracking.

These embodiments are illustrative and do not limit the scope of the invention.

What is claimed is:

1. A system for maintaining identity continuity of an entity under interruption, comprising:
(a) a data acquisition interface configured to receive telemetry associated with the entity;
(b) one or more processors configured to maintain a persistent internal state for the entity that is addressable independent of continuous external observation; and
(c) a synchronization interface configured to:
(i) detect an interruption condition in which the telemetry is at least one of degraded, delayed, partially unavailable, unreliable, or received out of order, such that the telemetry is insufficient to satisfy a continuity validation criterion;
(ii) during the interruption condition, maintain an identity authority association between an identity of the entity and the persistent internal state such that the persistent internal state is not reinitialized due to the interruption condition; and
(iii) upon availability of restored information associated with the entity, including restored telemetry or one or more correspondence artifacts, perform validated re-association between the restored information and the persistent internal state to re-establish the identity authority association, and to preserve identity continuity using the persistent internal state without reinitialization;
wherein the identity authority association is provided as an identity authority output consumable by downstream system components, the identity authority output indicating whether the identity associated with the entity is authorized for use during and following the interruption.

2. A method for maintaining identity continuity of an entity under interruption, comprising:
(a) maintaining a persistent internal state for the entity that is addressable independent of continuous external observation;
(b) detecting an interruption condition in telemetry associated with the entity, wherein the interruption condition comprises at least one of degradation, delay, partial unavailability, unreliability, out-of-order receipt, or other conditions that reduce telemetry sufficiency for continuous identity association;
(c) during the interruption condition, maintaining an identity authority association between an identity of the entity and the persistent internal state without reinitializing the persistent internal state due to the interruption condition; and
(d) upon receipt of restored information, including restored telemetry, performing validated re-association between the restored information and the persistent internal state and, when correspondence is validated, re-establishing identity authority association for the entity following the interruption and preserving identity continuity using the persistent internal state.

3. The system of claim 1, wherein maintaining the identity authority association comprises maintaining a persistent state-link that governs identity continuity behavior following interruption, including behavior associated with identity drift, duplicate identity instantiation, incorrect reassignment, distributed state divergence, or reset cascades.

4. The system of claim 1, wherein validated re-association comprises determining whether restored information corresponds to the persistent internal state and, upon validation of correspondence, re-establishing the identity authority association for the entity following the interruption.

5. The system of claim 1, wherein the persistent internal state is maintained independently of continuous surface visibility by performing surface-independent state mapping (SISM).

6. The system of claim 5, wherein surface-independent state mapping generates or updates the persistent internal state from multi-modal telemetry, contextual state information, or both, independent of any single observable surface or sensor stream.

7. The system of claim 1, wherein the system is configured to preserve identity continuity across heterogeneous compute environments comprising at least one of edge, cloud, or distributed execution environments.

8. The system of claim 7, wherein the system is configured to preserve identity continuity as execution or authority over the persistent internal state transitions between heterogeneous compute environments without reinitializing the persistent internal state.

9. The system of claim 7, wherein the synchronization interface is configured to perform asynchronous temporal reconciliation to compensate for accumulated state divergence or clock skew during interruption between the heterogeneous compute environments.

10. The system of claim 1, wherein the system is configured to maintain separate persistent internal states for a plurality of entities whose telemetry overlaps in space or time.

11. The system of claim 10, wherein the persistent internal state supports dynamic bifurcation or fusion, allowing the association to remain addressable as an entity divides into or merges from a plurality of discrete units while preserving identity continuity.

12. The system of claim 1, wherein the association between the identity and the persistent internal state may be maintained using anonymized cryptographic hashes, such that identity continuity may be supported without requiring storage of raw personally identifiable information.

13. The system of claim 1, wherein maintaining the persistent internal state includes performing constrained extrapolation using environmental boundaries or physics-based models to prevent the persistent internal state from violating spatial or logical limits.

14. The system of claim 1, wherein the synchronization interface is configured to maintain a confidence measure associated with the persistent internal state during the interruption condition and, when the confidence measure crosses a threshold, to modify continuity behavior by limiting downstream state propagation or actuation, while preserving identity authority association and without reinitializing the persistent internal state.

15. The system of claim 1, wherein the synchronization interface is configured to generate multi-modal feedback to the entity based on a state of the persistent internal state, including at least one of visual, haptic, or auditory feedback.

16. The system of claim 1, wherein the synchronization interface is configured to support temporal reconciliation of delayed, latent, or out-of-order telemetry using one or more temporal correlation mechanisms.

17. The system of claim 1, wherein the persistent internal state is configured to ingest telemetry from legacy sensors and map the telemetry via a universal schema-agnostic interface.

18. The system of claim 1, wherein the persistent state-link is supported using versioned state checkpoints, rollback markers, reconciliation markers, or other continuity mechanisms configured to support continuity of the persistent state-link following telemetry interruption.

19. The system of claim 1, wherein the synchronization interface is configured to provide an identity authority output to one or more downstream subsystems, the identity authority output comprising:
(a) a stable identity reference for the entity; and
(b) an associated confidence bound during the interruption condition;
wherein the downstream subsystems are configured to inhibit creation of a new identity instance for the entity unless the validated re-association fails or the identity authority association is revoked.

20. The system of claim 1, wherein validated re-association comprises resolving an ambiguity between a plurality of candidate persistent internal states corresponding to restored information, and maintaining non-selected persistent internal states without reinitialization while preserving identity authority for a selected persistent internal state.

21. The system of claim 1, wherein the validated re-association is performed using one or more correspondence artifacts asynchronous to or independent of real-time telemetry, the correspondence artifacts comprising at least one of a state checkpoint identifier, state digest, continuity attestation, authority token, or policy-derived continuity reference associated with the persistent internal state.

22. The system of claim 1, wherein identity continuity is preserved across the heterogeneous compute environments without requiring a centralized identity manager or centralized orchestration, thereby enabling distributed maintenance of the identity authority association.
